(19) United States
(12) Patent Application Publication
(10) Pub. No.: US 2026/0001503 A1
(43) Pub. Date: Jan. 1, 2026

(54) VEHICLE BUMPER COVER OR SOFT NOSE FASCIA

(71) Applicant: FCA US LLC, Auburn Hills, MI (US)

(72) Inventors: Zhenghong Yan, Shanghai (CN); Ziye Wang, Shanghai (CN); Dan Li, Shanghai (CN); Wenbin Song, Shanghai (CN); Bing Li, Shanghai (CN)

(21) Appl. No.: 18/758,206

(22) Filed: Jun. 28, 2024

(51) Int. Cl. B60R 19/02

(52) U.S. Cl. CPC B60R 19/023

(57) ABSTRACT

A vehicle bumper cover has a soft nose fascia and a reinforcement. A plurality of hooks, as well as a plurality of clips, are on the soft nose fascia. A plurality of channels is formed in the reinforcement to receive the hooks. A plurality of apertures is formed in the reinforcement to receive the plurality of clips. The reinforcement is elongated and extends between sides of the nose fascia to provide a securement beam to attach with a vehicle framework.

The present application is related in general subject matter to pending U.S. patent application Ser. No. ______ (Attorney Docket No. 712340US1), filed concurrently herewith, entitled “Front Bumper Assembly,” assigned to FCA US LLC, and hereby incorporated by reference in its entirety into the present application. The present application is further related in general subject matter to pending commonly assigned U.S. patent application Ser. No. ______ (Attorney Docket No. 712342US1), filed concurrently herewith, entitled “Support Bracket For A Front Vehicle Fascia,” hereby incorporated by reference in its entirety into the present application.

### FIELD

The present disclosure relates to automotive vehicles and, more particularly, to a vehicle bumper cover or soft nose fascia.

### BACKGROUND

This section provides background information related to the present disclosure which is not necessarily prior art.

A front bumper of a vehicle generally includes a bumper cover or nose fascia that is received onto the vehicle body. The bumper cover or nose fascia generally is plastic and over a period of time is subjected to sag that causes an unpleasant aesthetic appearance. Thus, it would be desirable to have a front bumper cover or nose fascia that is supported again sag to provide a pleasing aesthetic appearance. Accordingly, the present disclosure provides such a bumper cover.

### SUMMARY

This section provides a general summary of the disclosure, and is not a comprehensive disclosure of its full scope or all of its features.

The present disclosure provides a reinforced bumper cover. The present disclosure provides a plurality of securement members to secure the bumper cover to the reinforcement.

According to a first aspect of the disclosure, a vehicle bumper cover comprises a soft nose fascia and a reinforcement. A plurality of hooks are on the soft nose fascia and a plurality of clips are on the soft nose fascia to secure with the reinforcement. A plurality of channels are formed in the reinforcement to receive the hooks. A plurality of apertures are formed in the reinforcement to receive the plurality of clips. The reinforcement is elongated and extends between sides of the fascia to provide a securement beam to attach with a vehicle framework. A plurality of latches are adjacent the apertures on the reinforcement. A plurality of catches is on the plurality of clips to secure the clips in the apertures against movement in an X and Y direction (side to side, front to back with respect to the vehicle). The plurality of hooks engage the plurality of channels to secure the fascia in a Z direction (up and down with respect to the vehicle). The fascia includes bores to receive fasteners to secure the bumper fascia to the vehicle. The reinforcement includes bores to receive fasteners to secure the reinforcement to the vehicle framework.

According to a second aspect of the disclosure, a vehicle with a bumper cover comprises an aperture or frame on the vehicle to secure the bumper cover. The framework includes bores to receive fasteners. A plurality of hooks are on the soft nose fascia and a plurality of clips are on the soft nose fascia to secure with the reinforcement. A plurality of channels are formed in the reinforcement to receive the hooks. A plurality of apertures are formed in the reinforcement to receive the plurality of clips. The reinforcement is elongated and extends between sides of the fascia to provide a securement beam to attach with a vehicle framework. A plurality of latches are adjacent the apertures on the reinforcement. A plurality of catches is on the plurality of clips to secure the clips in the apertures against movement in an X and Y direction (side to side, front to back with respect to the vehicle). The plurality of hooks engage the plurality of channels to secure the fascia in a Z direction (up and down with respect to the vehicle). The fascia includes bores to receive fasteners to secure the bumper fascia to the vehicle. The reinforcement includes bores to receive fasteners to secure the reinforcement to the vehicle framework.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a bumper cover.

FIG. 2 is a bottom perspective view of a fascia reinforcement.

FIG. 3 is a cross-section view along line 3-3 of FIG. 1.

FIG. 4 is an enlarged view of a securement hook.

FIG. 5 is a perspective cross-section view along line 5-5 of FIG. 4.

FIG. 6 is a cross-section view along 6-6 of FIG. 4.

FIG. 7 is an enlarged perspective view of a fascia clip on the reinforcement.

FIG. 8 is a cross-section view of FIG. 7 along line 8-8.

FIG. 9 is a top perspective view of the fascia on a vehicle body.

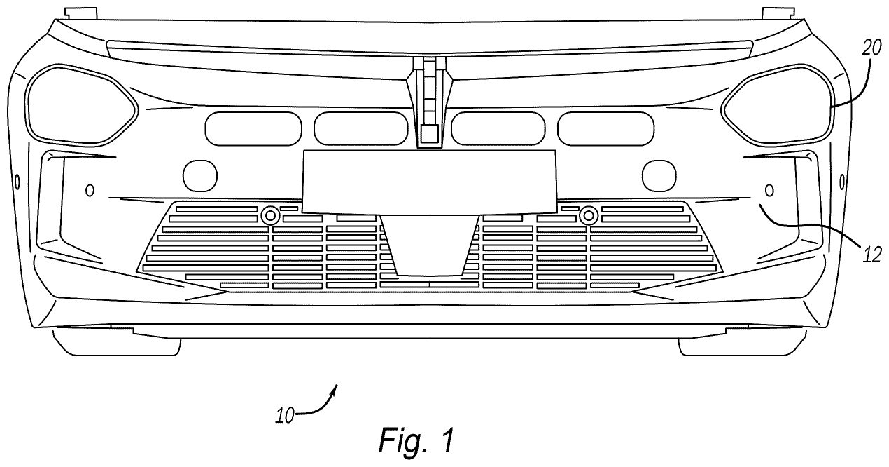

Corresponding reference numerals indicate corresponding parts throughout the several views of the drawings.

### DETAILED DESCRIPTION

Example embodiments will now be described more fully with reference to the accompanying drawings.

Turning to the figures, a bumper cover assembly is illustrated and designated with the reference numeral 10. The bumper cover assembly 10 includes a soft nose fascia 12 secured with a reinforcement member 14. The nose fascia 12 is secured to the reinforcement member 14 via a plurality of hooks 16 and clips 18.

The fascia 12 has an overall nose configuration, extending between the vehicle front fenders to cover the front bumper of a vehicle. The fascia 12 includes various openings 20 to receive headlights, daytime running lamps or the like. Also, the fascia 12 has a curvature, being curved between the fenders of a vehicle. Thus, the fascia 12 has, at its top edge, is curved from side to side as illustrated in FIG. 9.

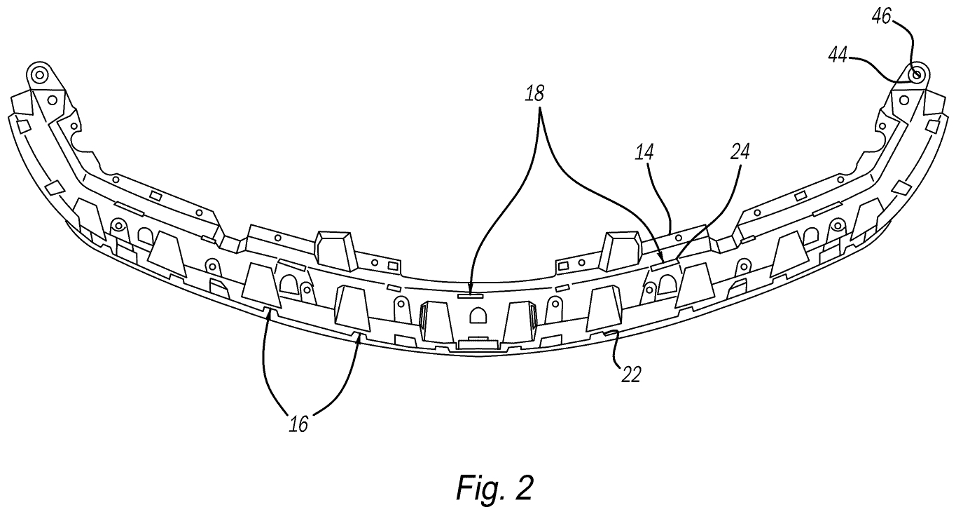

The reinforcement 14 has an overall elongated U-shape and is fit at the top edge of the fascia as illustrated in FIG. 9. The reinforcement 14 includes a plurality of channels 22 to receive the plurality of hooks 16. Also, the reinforcement includes a plurality of apertures 24 that receive the plurality of clips 18. This is best illustrated in FIG. 2.

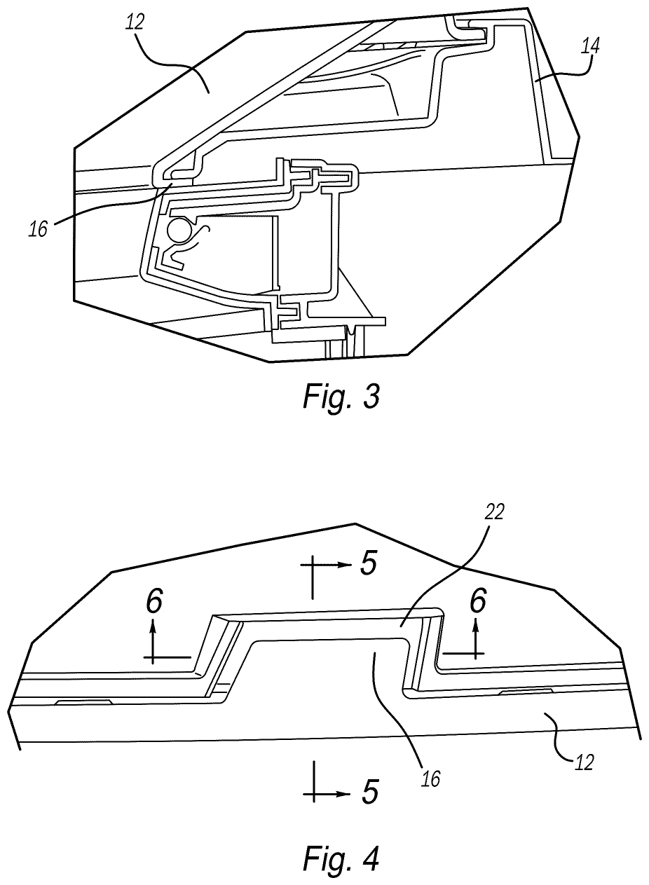

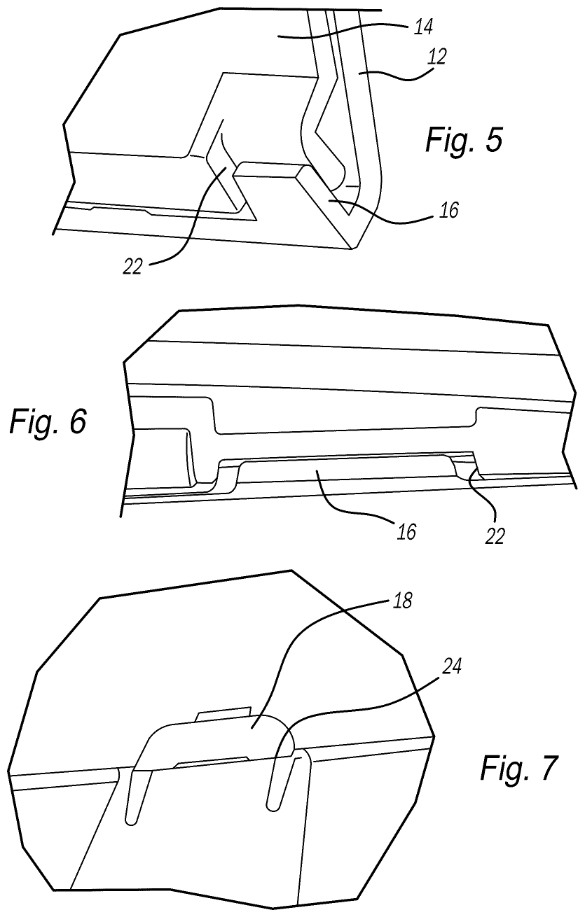

Turnings to FIGS. 3-6, a better understanding of the hook fastener 16 and the channels 22 will be had. The hooks 16 extends from an edge of the fascia 12. The hooks extend inwardly and fits into the reinforcement channel 22. Thus, the hooks 16 engage in the channels 22 to secure the fascia 12 on the reinforcement 14 in a Z direction. The hooks engage at an edge end of the nose reinforcement member 16. Thus, the nose fascia 12 is secured against up and down, Z movement, with the respect to the vehicle, by the hooks 16.

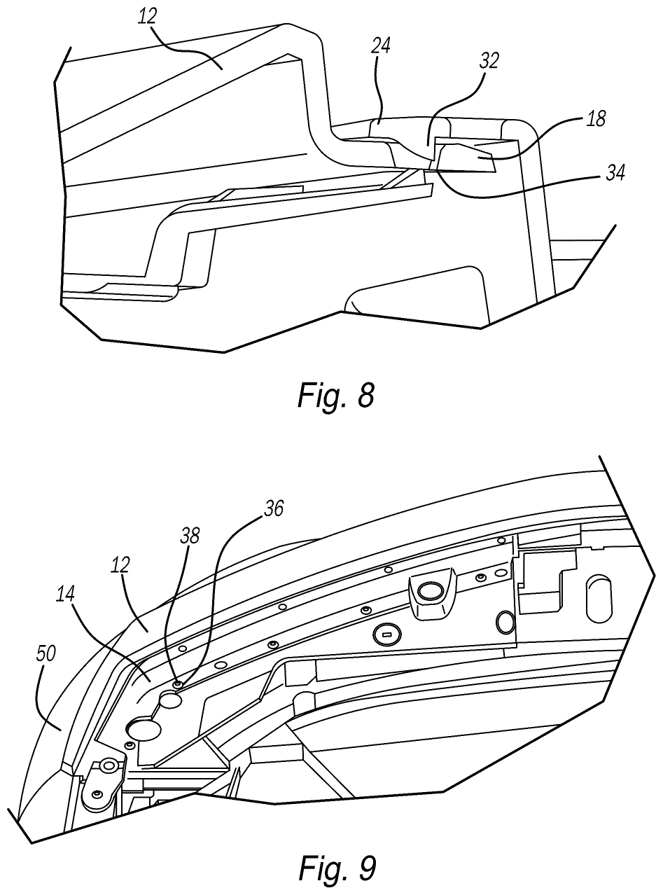

Turning to FIGS. 7 and 8, the clips 18 and the reinforcement apertures 24 are illustrated. Here, the reinforcement member 14 includes a latch 32, such as a barb, adjacent the aperture 24 to receive a catch 34, such as an aperture, of the clip 18. The latch 32 acts as a barb extending into the catch valley 34 to secure the clips 18 within the reinforcement apertures 24 so that the fascia 12 is secured with the reinforcement 14 in a X and Y direction or front to back and side to side with respect to the vehicle. Thus, as the clips 18 and hooks 16 are positioned onto the reinforcement member 14, as illustrated in FIG. 2, the nose fascia 12 is secured to the reinforcement member 14 and is locked in place with respect to front and back, side to side and up and down movement with respect to the vehicle. Thus, the hooks 16 and clips 18 design of the nose fascia 12 eliminates push pins or the like that were utilized to retain the fascia onto the vehicle.

Also, the reinforcement 14 includes a plurality of bores 36 that receive fasteners 38 to secure the reinforcement 14 and nose fascia 12 to the framework 40 of a vehicle. Additionally, the nose fascia 12 includes an extending arm portions 44 with an aperture 46 that receives a fastener 48 to secure the nose fascia 12 with fenders 50. Thus, the nose fascia 12 is secured onto the vehicle framework 40, via the reinforcement 14, that secures the nose fascia 12 to it by the hook 16 and clip 18 design.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle bumper cover comprising:
a soft nose fascia and a reinforcement;
a plurality of hooks are on the soft nose fascia and a plurality of clips are on the soft nose fascia;
a plurality of channels are formed in the reinforcement for receiving the hooks;
a plurality of apertures are formed in the reinforcement for receiving the plurality of clips; and
the reinforcement is elongated and extends between sides of the nose fascia for providing a securement beam to attach with a vehicle framework.

2. The vehicle bumper cover of claim 1, wherein a plurality of latches is adjacent the apertures on the reinforcement.

3. The vehicle bumper cover of claim 2, wherein a plurality of catches is on the plurality of clips for securing the clips in the reinforcement apertures in an X and Y direction or front to back and side to side with respect to the vehicle.

4. The vehicle bumper cover of claim 1, wherein the plurality of hooks engages the plurality of channels to secure the nose fascia in a Z or up and down direction with respect to the vehicle.

5. The vehicle bumper cover of claim 1, wherein the nose fascia includes bores to receive fasteners to secure the nose fascia to a vehicle.

6. The vehicle bumper cover of claim 1, wherein the reinforcement includes bores to receive fasteners to secure the reinforcement to the vehicle frame.

7. A vehicle with a bumper cover comprising:
a framework on the vehicle for securing the bumper cover, the framework including bores for receiving fasteners;
a soft nose fascia and a reinforcement;
a plurality of hooks are on the soft nose fascia and a plurality of clips are on the soft nose fascia;
a plurality of channels are formed in the reinforcement for receiving the hooks;
a plurality of apertures are formed in the reinforcement for receiving the plurality of clips; and
the reinforcement is elongated and extends between sides of the nose fascia for providing a securement beam to attach with a vehicle framework.

8. The vehicle with bumper cover of claim 7, wherein a plurality of latches is adjacent the apertures on the reinforcement.

9. The vehicle with bumper cover of claim 8, wherein a plurality of catches is on the plurality of clips for securing the clips in the reinforcement apertures in an X and Y direction or front to back and side to side with respect to the vehicle.

10. The vehicle with bumper cover of claim 7, wherein the plurality of hooks engages the plurality of channels to secure the nose fascia in a Z or up and down direction with respect to the vehicle.

11. The vehicle with bumper cover of claim 7, wherein the nose fascia includes bores to receive fasteners to secure the nose fascia to a vehicle.

12. The vehicle with bumper cover of claim 7, wherein the reinforcement includes bores to receive fasteners to secure the reinforcement to the vehicle frame.
